(19) United States
(12) Patent Application Publication
(10) Pub. No.: US 2003/0227565 A1
(43) Pub. Date: Dec. 11, 2003

(54) Auxiliary information processing system with a bitmapped on-screen display using limited computing resources

(76) Inventors: Thomas Herman Hamilton, Indianapolis, IN (US); Dale Wayne King, Noblesville, IN (US)

Correspondence Address: Joseph S Tripoli, Thomson Multimedia Licensing Inc, PO Box 5312, Princeton, NJ, 08543-5312, US

(21) Appl. No.: 10/296,690

(22) PCT Filed: Jun. 1, 2001
(86) PCT No.: PCT/US01/17744

(51) Int. Cl. H04N 11/00

(52) U.S. Cl. 348/468; 348/569

(57) ABSTRACT

A system for processing auxiliary information included in a television signal provides on-screen bitmapped displays using limited computing and memory resources. According to an exemplary embodiment, closed caption data is received in a vertical blanking interval (VBI) of a television signal or in one or more packets of digital data. A display list is generated in dependence upon the received closed caption data. The display list includes a bitmap pointer which points to bitmap data in a memory. The display list may also include: resolution data indicating a number of bits per pixel to be provided in the closed caption display, height data indicating a character height in pixels for the closed caption display, and width data indicating a character width in pixels for the closed caption display. The bitmap data is output as pixel data for the closed caption display. The closed caption display may be scrolled by manipulating the bitmap pointer.

### BACKGROUND OF THE INVENTION

1. Field of the Invention

The present invention relates generally to enabling on-screen displays (OSDs) in systems such as a television signal receiver, and more particularly, to a method and system for providing auxiliary information, such as closed captioning or teletext, with a bitmapped OSD using limited computing resources.

2. Description of the Related Art

Systems such as television signal receivers display images based on information contained in electrical signals received by the system. In addition to a main image, such systems may also provide display of auxiliary information such as closed caption or teletext information. Data required to produce an auxiliary information display is included as an auxiliary information component of a television signal. The data defines both the information that will be displayed and the format of the displayed information.

Other types of auxiliary information may also be included in displayed images. For example, teletext data may be displayed. Also, information such as an electronic program guide may be displayed to inform a viewer about programs that are available for viewing. The data needed to produce such displays may also be included as an auxiliary information component of the television signal. Such auxiliary information may be included within a particular portion of a television signal, such as the vertical blanking interval (VBI) in an analog system or as particular packets of data in a digital system.

Certain types of auxiliary information may be used to produce displayed images that represent information occurring in real-time in the television programming provided by the television signal. For example, teletext data or closed captioning data may be extracted from the television signal and decoded to produce displayed text in the form of a caption associated with the video program. The caption provides a visible representation of the real-time audio program component of the televison program. Such real-time information requires real-time updates of text display on a screen as the auxiliary information is received. Other features that should be supported for display of auxiliary information such as closed captioning are characteristics, or format parameters, of the display of the auxiliary information that are also defined by the auxiliary information and may change in real time. Examples of such display characteristics include smooth scrolling, italics, underlining, various color foreground/background combinations per character, and character flashing.

While a bitmapped OSD system may accommodate these features, there are problems associated with using such a system for closed captioning. For example, in a conventional bitmapped OSD system, the aforementioned display features can utilize significant central processing unit (CPU) and memory resources. A conventional bitmap display system typically stores each pixel in a display buffer within a memory, such as a random access memory (RAM). The display buffer typically contains a number of bytes for each pixel in order to describe its color and transparency characteristics. To change the display for a given portion of the screen, the pixel data for that portion of the screen must be changed in the display buffer. This typically requires the new pixel data to be moved from another memory location into the display buffer. This movement of pixel data uses large amounts of CPU and memory bus bandwidth. If the system does not have sufficient CPU speed or memory bandwidth, the movement cannot be done fast enough, thereby resulting in sluggish display performance and/or other undesirable effects on the screen. This type of performance is not acceptable for an auxiliary information processing system which requires real-time updates of text display on a screen as the auxiliary information is received. Accordingly, there is a need to provide an auxiliary information processing system using a bitmapped OSD that addresses these and other problems.

### SUMMARY OF THE INVENTION

The present invention provides a system for processing an auxiliary information component of a television signal that provideson-screen bitmapped displays using limited computing and memory resources. According to an exemplary embodiment, auxiliary information is received in a vertical blanking interval (VBI) of a television signal or in one or more packets of digital data. A display list is generated in dependence upon the received auxiliary information. The display list includes a bitmap pointer which points to bitmap data in a memory. The display list may also include: resolution data indicating a number of bits per pixel to be provided in the auxiliary information display, height data indicating a character height in pixels for the auxiliary information display, and width data indicating a character width in pixels for the auxiliary information display. The bitmap data is output as pixel data for the auxiliary information display. The auxiliary information display may be scrolled by manipulating the bitmap pointer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic diagram of relevant portions of a system suitable for implementing the present invention;

FIG. 2 is a schematic block diagram illustrating further details of the system shown in FIG. 1;

FIG. 3 is a flowchart summarizing the general operation of the system illustrated in FIGS. 1 and 2;

FIG. 4 is an exemplary closed caption display according to principles of the present invention;

FIG. 5 is an exemplary closed caption font memory according to principles of the present invention; and

FIGS. 6A through 6D illustrate a scrolling process according to principles of the present invention.

The exemplifications set out herein illustrate preferred embodiments of the invention, and such exemplifications are not to be construed as limiting the scope of the invention in any manner.

### DETAILED DESCRIPTION OF THE INVENTION

In the following description, exemplary embodiments of the invention are described in the context of a closed captioning system. However, as will be apparent, the invention is also applicable to other types of auxiliary information such as teletext.

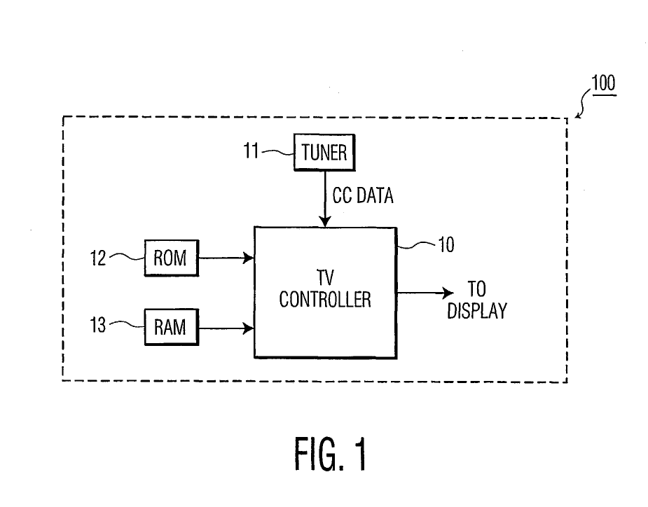

Referring now to the drawings, and more particularly to FIG. 1, a schematic diagram of a system suitable for implementing the present invention is shown. In FIG. 1, a system 100 such as a television signal receiver includes a controller 10, which may be embodied as one or more integrated circuits (ICs). A tuner 11 extracts closed caption data from an incoming video signal, and provides the extracted closed caption data to the controller 10. The closed caption data may be extracted from a particular portion of the video signal, such as the vertical blanking interval (VBI) in an analog system or as one or more packets of digital data in a digital system. A read-only memory (ROM) 12 stores bitmap and font data, and also stores a program that is executed by the controller 10 to parse the closed caption data and generate a closed caption display according to principles of the present invention. A random access memory (RAM) 13 stores bitmap data and a display list created by the controller 10 during the process of generating a closed caption display according to principles of the present invention. As will be explained further hereinafter, the use of a display list architecture allows a software developer to divide a display region, such as a television screen, into rectangular regions referred to as tiles. Each tile may have the following descriptors: a bitmap pointer, a palette index, a resolution, a height, and a width. The bitmap pointer points to a character bitmap location in ROM 12 or RAM 13 to be displayed in the tile. The palette index specifies the color and/or transparency attributes of a particular tile. The resolution specifies the number of bits per pixel of the bitmap to be displayed. According to a preferred embodiment, the resolution of each tile is preferably one bit per pixel to minimize memory usage. The height specifies the height of a tile in pixels. The width specifies the width of a tile in pixels. According to a preferred embodiment, closed captions are displayed as a grid of 15 rows of 34 character cells, with each cell being the same vertical and horizontal size, 26 by 16 pixels. In the system 100 of FIG. 1, each of these closed caption character cells is implemented as a single tile. Special character effects, such as underlining and italics are implemented as separate character fonts in the ROM 12.

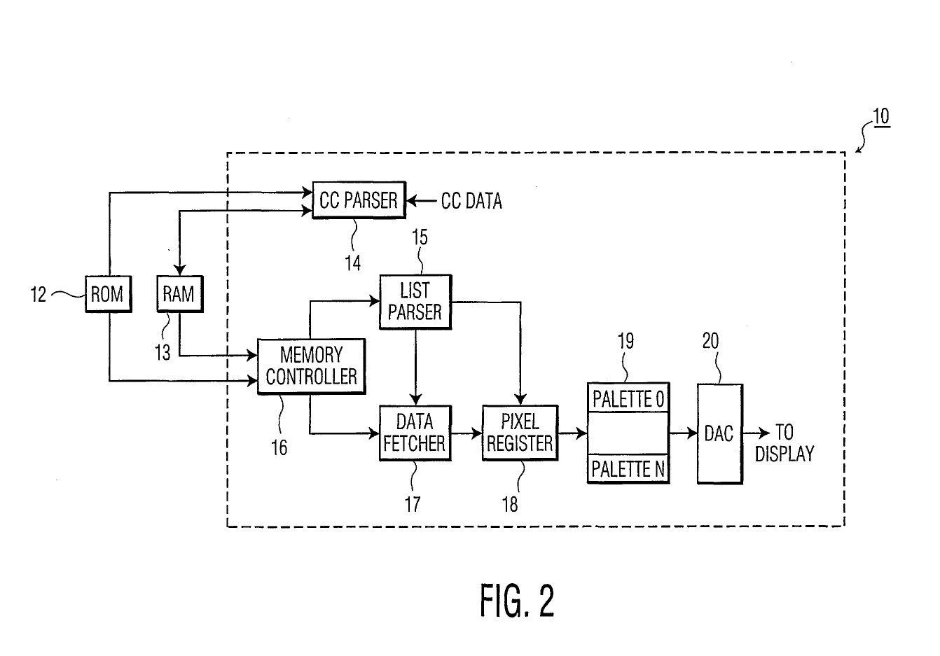

Turning now to FIG. 2, further details of the system 100 shown in FIG. 1 are illustrated. In particular, FIG. 2 illustrates additional details of the controller 10. The controller 10 includes a closed caption parser 14 implemented in software which parses the incoming closed caption data to create a display list in the RAM 13. As previously indicated, the display list includes data representative of the closed caption display and is arranged such that each closed caption character cell may include the following previously defined descriptors: a bitmap pointer, a palette index, a resolution, a height, and a width. A list parser 15 retrieves display list data from the RAM 13 by providing address information to a memory controller 16. The list parser 15 parses the display list to extract the bitmap pointers and palette indexes. The list parser 15 transmits the extracted bitmap pointers to a data fetcher 17. The data fetcher 17 receives bitmap data from the ROM 12 or RAM 13 through the memory controller 16 based on the bitmap pointers provided by the list parser 15. The data fetcher 17 transmits the received bitmap data as individual pixel data to a pixel register 18. The pixel register 18 also receives the extracted palette indexes from the list parser 15, and outputs the pixel data and palette indexes to a palette memory 19 on a first-in, first-out (FIFO) basis. The palette indexes operate as address pointers for reading the pixel data out of the palette memory 19. As shown in FIG. 2, the palette memory 19 includes a predetermined number of palette entries designated 0 through N. Each palette entry corresponds to a given color and/or transparency attribute. A digital-to-analog converter (DAC) 20 reads the pixel data out of the palette memory 19, performs a digital-to-analog conversion process, and outputs the analog results to a display portion of the system 100. The analog outputs may be in a format such as RGB (i.e., red, green, blue).

The aforementioned system 100 for displaying closed caption characters has several advantages over conventional techniques. For example, the character bitmaps are not rendered in an OSD buffer memory. Instead, the content of a given character cell is changed by simply changing the bitmap pointer of the appropriate character cell. This saves significant CPU execution time and memory over conventional bitmap rendering techniques. Also in the system 100, changing the color of a closed caption character requires only that the palette index of the character cell be changed. This technique is also used to change the background color of closed caption text, and for flashing characters on and off as quickly as desired. Again, this saves significant CPU execution time, which is very important due to the dynamic nature of a closed caption display.

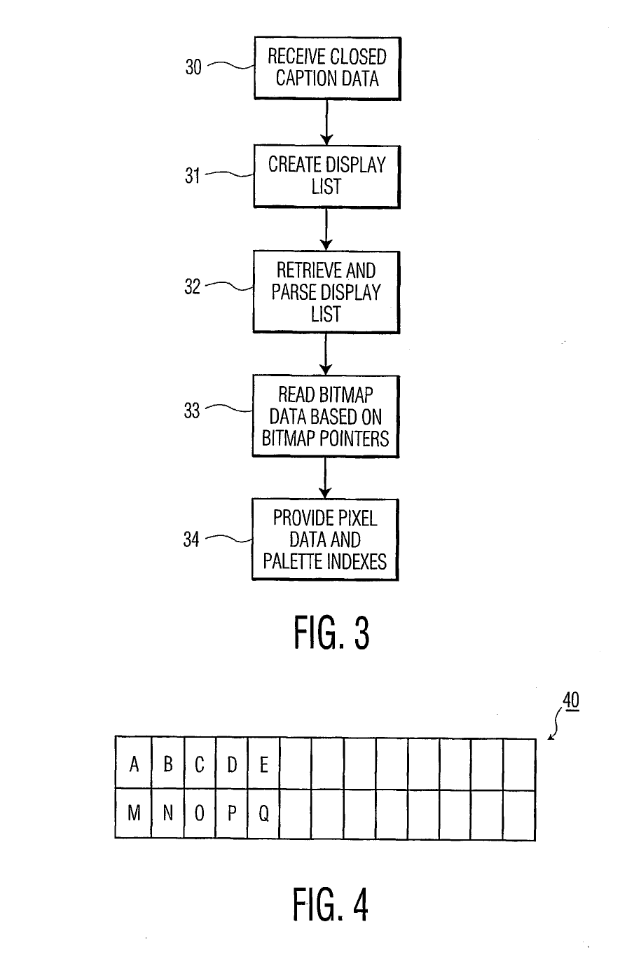

Turning now to FIG. 3, a flowchart summarizing the general operation of the system 100 is shown. The flowchart of FIG. 3 will be described in relation to FIG. 2. At step 30, the controller 10 receives the closed caption data. As previously indicated, the closed caption data may be received in a particular portion of the video signal, such as the vertical blanking interval (VBI) in an analog system or as one or more packets of digital data in a digital system. At step 31, the closed caption parser 14 of the controller 10 parses the received closed caption data to create the display list in the RAM 13. At step 32, the list parser 15 retrieves the display list data from the RAM 13 and parses the display list to extract the bitmap pointers and palette indexes. Next, at step 33, the data fetcher 17 reads bitmap data from the ROM 12 or RAM 13 based on the bitmap pointers provided by the list parser 15. Then, at step 34, the data fetcher 17 transmits the received bitmap data as individual pixel data to the pixel register 18, which provides the received pixel data and palette indexes to the palette memory 19.

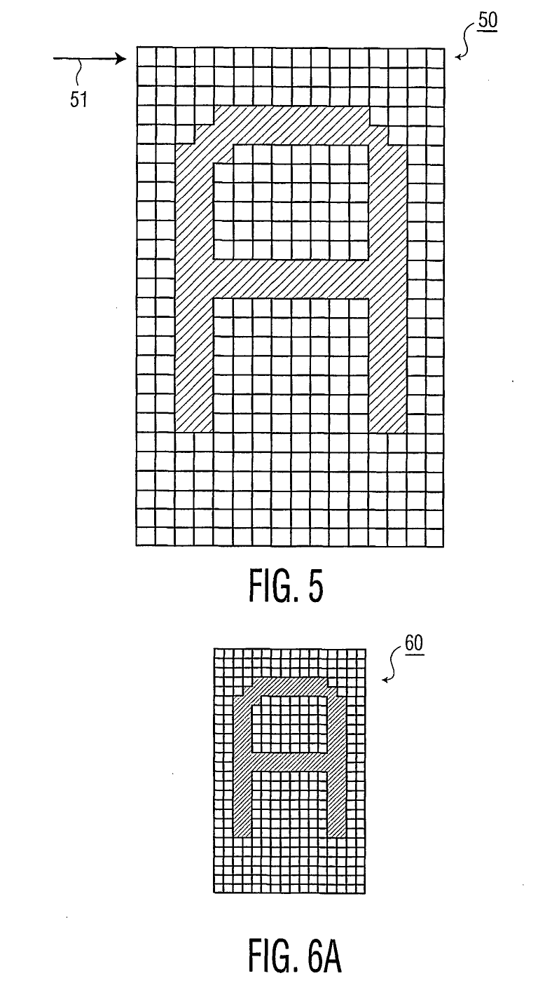

Turning now to FIG. 4, an exemplary closed caption display 40 according to principles of the present invention is shown. In particular, the closed caption display 40 provides two partial rows of alphabetic characters. The first row includes alphabetic characters “A,” “B,” “C,” “D” and “E,” while the second row includes alphabetic characters “M,” “N,” “O,” “P” and “Q.” Numeric and other types of characters and/or symbols may also be provided according to principles of the present invention.

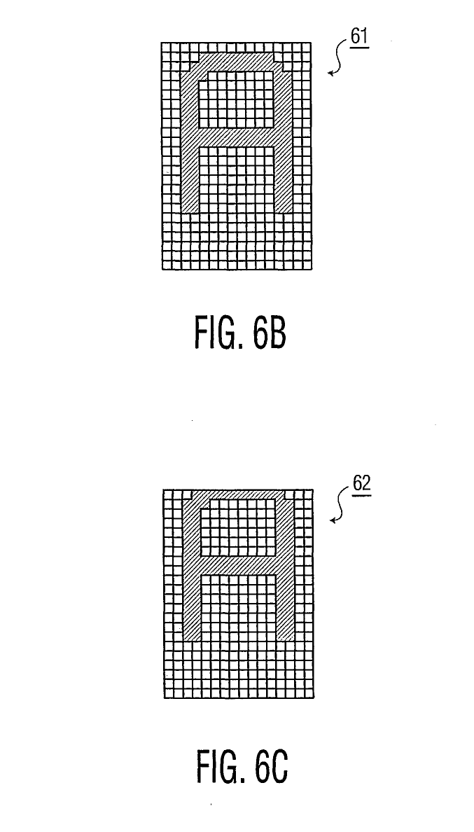

Turning now to FIG. 5, the contents of an exemplary closed caption font memory are shown. In particular, the closed caption font memory 50 of FIG. 5 illustrates the particulars of the first bitmap character cell “A” in the closed caption display of FIG. 4. The bitmap character cell exhibits a vertical size of 26 pixels, and a horizontal size of 16 pixels. In the present invention, the font memory of FIG. 5 is embodied within the ROM 12 or the RAM 13 of FIGS. 1 and 2. In FIG. 5, a bitmap pointer 51 points to a top row of pixels in the bitmap character cell. As will be explained hereinafter, the bitmap pointer may be used to facilitate a scrolling process according to principles of the present invention.

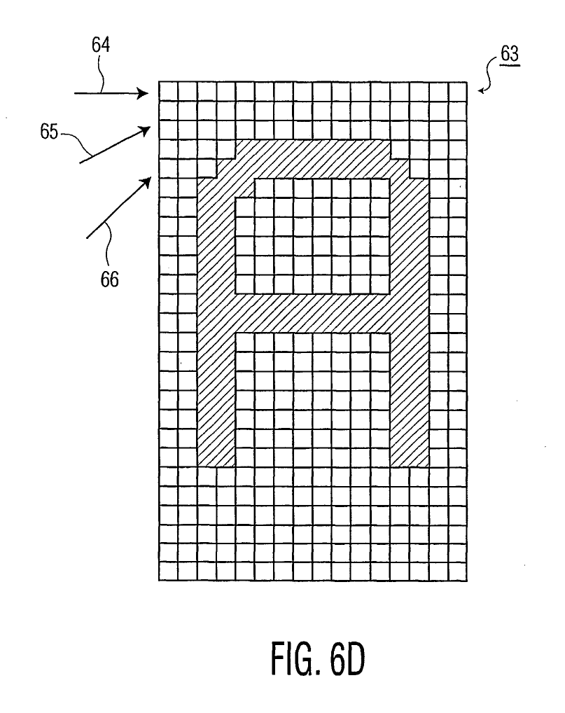

Turning now to FIGS. 6A through 6D, a scrolling process according to principles of the present invention will now be described. In FIG. 6A, a bitmap character cell 60 illustrates the alphabetic character “A” before the scrolling process begins. In this state, the height of the bitmap character cell 60 is 26 pixels. In FIG. 6B, a bitmap character cell 61 illustrates the alphabetic character “A” after a first step of the scrolling process. In this state, the height of the bitmap character cell 60 is 24 pixels. In FIG. 6C, a bitmap character cell 62 illustrates the alphabetic character “A” after a second step of the scrolling process. In this state, the height of the bitmap character cell 60 is 22 pixels. In FIG. 6D, a bitmap character cell 63 illustrates bitmap pointers 64, 65 and 66 corresponding to the states shown in FIGS. 6A through 6C, respectively. That is, the bitmap pointer 64 corresponds to the state before the scrolling process begins, as shown in FIG. 6A. The bitmap pointer 65 corresponds to the state after a first step of the scrolling process, as shown in FIG. 6B. The bitmap pointer 66 corresponds to the state after a second step of the scrolling process, as shown in FIG. 6C.

As indicated in FIGS. 6A through 6D, the scrolling process according to the present invention is performed by adjusting the position of the bitmap pointer. In the exemplary embodiment, each scrolling step shrinks the characters being scrolled out by removing the top two rows of pixels. It should be understood, however, that a different number of pixels may be removed to provide a smooth scrolling process in accordance with the principles of the present invention. In practice, closed caption text is displayed in a box containing a series of text rows, as shown in FIG. 4. As enough text is received to overflow the current closed caption text box, the topmost text row is smoothly scrolled up and out of the box, and a new empty row is scrolled into the box from the bottom. This scrolling is preferably accomplished smoothly within a relatively short period of time sufficient to provide acceptable visual results. Smooth scrolling requires that a series of uniform scrolling steps must be performed. According to the present invention, each vertical scrolling step shrinks the characters being scrolled by removing a number of pixel rows. Horizontal scrolling can be accomplished in a similar manner by manipulating the cell/tile widths, rather than their heights. With traditional bitmapped display techniques, the type of scrolling provided by the present invention would require rapid movement of blocks of bitmap data within an OSD display buffer, thereby utilizing significant CPU and memory resources. Using the tile/cell based technique of the present invention, scrolling is accomplished by simply manipulating the height or width attribute of the rows or columns to be shrunk or expanded, and by manipulating the bitmap pointers to eliminate pixel rows or columns of the character cells being scrolled.

As described herein, the present invention provides significant advantages over conventional closed captioning techniques. Although the present invention has been described in relation to a television signal receiver, the invention is applicable to various systems, either with or without display devices, and the phrases “television signal receiver” or “television system” as used herein are intended to encompass various types of apparatuses and systems including, but not limited to, television sets or monitors that include a display device, and systems or apparatuses such as a set-top box, video tape recorder (VTR), digital versatile disk (DVD) player, video game box, or personal video recorder (PVR) that may not include display devices.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

1. A method for enabling display of auxiliary information included in a television signal, comprising steps of:
receiving the auxiliary information;
generating a display list in dependence upon the received auxiliary information, wherein the display list includes a bitmap pointer which points to bitmap data in a memory; and
outputting the bitmap data as pixel data for producing a display representing the auxiliary information.

2. The method of claim 1, wherein the auxiliary information comprises information represenative of a real-time information component of the television signal.

3. The method of claim 1, wherein the auxiliary information comprises closed caption data, and wherein the display list further includes a palette index which indicates a color for the closed caption display.

4. The method of claim 1, wherein the auxiliary information comprises closed caption data, and wherein the display list further includes resolution data indicating a number of bits per pixel to be provided in the closed caption display.

5. The method of claim 1, wherein the auxiliary information comprises closed caption data, and wherein the display list further includes height data indicating a character height in pixels for the closed caption display.

6. The method of claim 1, wherein the auxiliary information comprises closed caption data, and wherein the display list further includes width data indicating a character width in pixels for the closed caption display.

7. The method of claim 1, wherein the auxiliary information comprises closed caption data, and further comprising a step of scrolling the closed caption display by manipulating the bitmap pointer.

8. The method of claim 1, wherein the auxiliary information comprises closed caption data, and wherein the closed caption data is received in a vertical blanking interval of a television signal.

9. The method claim 1, wherein the auxiliary information comprises closed caption data, and wherein the closed caption data is received in one or more packets of digital data.

10. A system for enabling display of auxiliary information included in a television signal, comprising:
a memory;
a controller for receiving the auxiliary information and for generating a display list in dependence upon the received auxiliary information, wherein the display list includes a bitmap pointer which points to bitmap data in the memory; and
circuitry for outputting the bitmap data as pixel data for the auxiliary information display.

11. The system of claim 10, wherein the auxiliary information comprises information associated with a real-time information component of the television signal.

12. The system of claim 11, wherein the auxiliary information comprises closed caption data and wherein the display list further includes a palette index which indicates a color for the closed caption display.

13. The system of claim 11, wherein the auxiliary information comprises closed caption data and wherein the display list further includes resolution data indicating a number of bits per pixel to be provided in the closed caption display.

14. The system of claim 11, wherein the auxiliary information comprises closed caption data and wherein the display list further includes height data indicating a character height in pixels for the closed caption display.

15. The system of claim 11, wherein the auxiliary information comprises closed caption data and wherein the display list further includes width data indicating a character width in pixels for the closed caption display.

16. The system of claim 11, wherein the auxiliary information comprises closed caption data and wherein the closed caption display is scrolled by manipulating the bitmap pointer.

17. The system of claim 11, wherein the auxiliary information comprises closed caption data and wherein the closed caption data is received in a vertical blanking interval of a television signal.

18. The system of claim 11, wherein the auxiliary information comprises closed caption data and wherein the closed caption data is received in one or more packets of digital data.

19. A method of processing auxiliary information included in a television signal comprising the steps of:
extracting auxiliary information from the television signal, wherein the auxiliary information comprises data representative of a real-time information component of a television program included in the television signal;
generating a display list in dependence upon the received auxiliary information, wherein the display list includes a bitmap pointer which points to bitmap data in a memory; and
outputting the bitmap data as pixel data for producing a display representing the real-time information component of the television program.

20. The method of claim 19, wherein the real-time information component comprises the audio program portion of the television program, and wherein the auxiliary information comprises closed caption data or teletext data.

21. The method of claim 20, wherein the auxiliary information comprises information representative of a characteristic of the display produced in response to the pixel data, and wherein the step of generating the display list includes the step of modifying the display list responsive to the auxiliary information for updating the characteristic of the display in real-time.
